(19) United States
(12) Patent Application Publication
(10) Pub. No.: US 2016/0076293 A1
(43) Pub. Date: Mar. 17, 2016

(54) SYSTEM AND DEVICE FOR SOFT CLOSING

(71) Applicant: HARDOOR TOP DESIGN & TECHNOLOGY LTD, Rishon-LeZion (IL)

(72) Inventors: Amos HALFON, Sitriya (IL); Mordechai HARARI, Rishon-LeZion (IL)

(21) Appl. No.: 14/785,894

(22) PCT Filed: Apr. 17, 2014
(86) PCT No.: PCT/IL2014/050365

§ 371 Date: Oct. 21, 2015

Related U.S. Application Data
(60) Provisional application No. 61/814,597, filed on Apr. 22, 2013.

(51) Int. Cl. E05F 5/00; E05D 15/06

(52) U.S. Cl. CPC E05F 5/003; E05D 15/0686; E05D 15/0678; E05D 15/0652; E05Y 2900/20

(57) ABSTRACT

A system and a soft closing device installed over a track of a storage unit for preventing a closable component such as a sliding door, a movable shelf or a drawer, movable over this track from forcefully slamming against a frame wall of the storage unit. The system or soft closing device each comprises at least one guiding member having two opposite slopes creating a peak for forcing the closable component to ascend once reaching the soft closing device and thereby slow down its movement. The system or the device may optionally also include a buffer member for further buffering the closable component.

### CROSS-REFERENCE TO RELATED PATENT APPLICATIONS

This application claims priority to provisional patent application No. 61/814,597 filed on Apr. 22, 2013, which is incorporated herein by reference in its entirety.

### FIELD OF THE INVENTION

The present invention generally relates to devices, apparatuses and/or systems for preventing slamming and soft closing of doors or drawers.

### BACKGROUND OF THE INVENTION

Sliding doors are used in a variety of structures for opening and closing thereof such as in storage units, gates, rooms doors etc. Storage units such as closets and cupboards having sliding doors are extremely comfortable and popular since they require less space when the doors are open. The sliding doors are usually configured to slide along upper and lower tracks built or installed in the closet unit or any other unit where the opening is set to be.

A sliding door can often be slammed against a frame wall of a storage unit such as a closet or a cabinet if the user applies excessive force to open or close it, which may force the door off its tracks and/or cause damage to it by having the side thereof forcefully hit the frame of the storage unit or lintel.

### SUMMARY OF THE INVENTION

According to one aspect of the invention, there is provided a soft closing device for preventing a closable component such as a sliding door, a drawer, a slidable shelf and the like from forcefully slamming against a wall frame of a storage unit. The closable component is connected to at least one sliding element such as a slider or a roller/wheel, configured for sliding or rolling over a track of the storage unit.

According to some embodiments, the closing device comprises a base section; and at least one guiding member having at least one protruding section connected to the base section, wherein the protruding section comprises two opposite slopes creating a peak for forcing the closable component to ascend once reaching the soft closing device and thereby slow down its movement, and wherein the soft closing device is installed over of the track of the storage unit either at an edge of the track or any other location along the track.

Optionally, each guiding member comprises two protruding sections forming a recess therebetween.

According to some embodiments, the soft closing device has grooves configured for interlocking or meshing with the track at an edge of the track that is adjacent to the frame wall of the storage unit.

According to some embodiments, the soft closing device is configured to be installed over an upper track of the storage unit such that the soft closing device is located above the upper track for a hovering sliding door closable compartment.

According to other embodiments, the soft closing device is configured to be installed over a lower track of the storage unit such that the soft closing device is located above the lower track for a sliding door closable compartment.

According to other embodiments, the soft closing device is configured to be installed over a track of the storage unit such that the soft closing device is located above the track for a drawer closable compartment.

According to some embodiments, the soft closing device further comprises a buffer member combined therewith, located at a proximal edge in respect to the frame wall, for buffering the closable element when the slidable member slides or rolls through the slope of the protruding section when reaching an edge of the protruding section.

Optionally, the buffer member comprises at least one piston movable in a designated piston tube.

According to some embodiments, the soft closing device further comprises at least one fixating mechanism for fixating the soft closing device to the track.

According to another aspect of the present invention, there is provided a system for soft closing for preventing a closable component from forcefully slamming against a frame wall of a storage unit. The system comprises: (a) a guiding member comprising: a base section; and at least one protruding section connected to the base section, wherein the protruding section comprises two opposite slopes creating a peak for forcing the closable component to ascend once reaching the guiding member and thereby slow down movement of the closable component, wherein each guiding member is installed at the edge of the track in proximity to the frame wall of the storage unit; and (b) a buffer member installed at an edge of said closable component or at an edge of said wall frame for further buffering the movement of the closable component.

According to some embodiments, the buffer member is installed at an edge of an upper track of the storage unit that is adjacent to the frame wall and the guiding member is installed at an edge of a lower track of the storage unit at an edge that is adjacent to the frame wall.

According to some embodiments, each guiding member comprises two protruding sections forming a recess therebetween.

According to some embodiments, each guiding member has grooves configured for interlocking or meshing with the track at an edge of the track that is adjacent to the frame wall of the storage unit.

According to some embodiments, the buffer member comprises at least one piston movable in a designated piston tube.

### BRIEF DESCRIPTION OF THE DRAWINGS

FIG. 1 schematically illustrates a closet having a system for preventing door slamming including a soft closing device having multiple triangularly shaped elevated protruding sections and a piston based buffer apparatus installed at an upper part of the frame wall of the closet, according to some embodiments of the invention.

FIG. 2 shows details of the soft closing device, according to some embodiments of the invention.

FIG. 3 shows a zoom-in view of the soft closing device shown in FIG. 2.

FIG. 4 shows details of a buffer apparatus of the system for preventing door slamming, according to some embodiments of the invention.

FIG. 5 shows a closet having sliding doors with a soft closing device for preventing door slamming installed at an upper track of the closet, according to other embodiments of the invention.

FIG. 6 shows a detailed view of the soft closing device, shown in FIG. 5, installed at the upper track of the closet, according to some embodiments of the invention.

FIGS. 7A and 7B show a detailed view of the soft closing device, shown in FIGS. 5-6, according to some embodiments of the invention: FIG. 7A shows how wheel sliding elements of the sliding assembly are positioned in respect to the soft closing device; and FIG. 7B shows a detailed view of the soft closing device.

### DETAILED DESCRIPTION OF SOME EMBODIMENTS OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention, in some embodiments thereof, provides a soft closing devise and a system for soft-closing that allows preventing a closable component such as a sliding door or a drawer from slamming against a frame wall of an opening of a structure such as an opening of a room, a storage unit (e.g. closet), a window and the like. The sliding door is configured to slide along at least one track optionally between an upper track and a lower track by connecting to one or more sliding elements such as one or more wheels configured for sliding along the lower and/or upper track.

According to some embodiments, one or more sides of the sliding door connects to a profile for reinforcement thereof, where the sliding element connects to the profile through a connector allowing thereby to slide the door along the track (e.g. left and right).

According to some embodiments, the device includes a base section and one or more protruding sections connected thereto. The device is located at a lower or upper location in proximity to the frame wall at the edge of the lower or upper track to allow the sliding element to slide thereover when reaching the edge of the track, or at any other location over the track.

Each protruding section has an elevated shape (e.g. a hill or triangular shape) forcing the sliding element (e.g. a wheel sliding element) to slide upwards until reaching a peak of the elevation before interfacing the wall of the frame thereby slowing down (decelerating) the sliding door at the end of its sliding track for preventing slamming thereof against the frame wall.

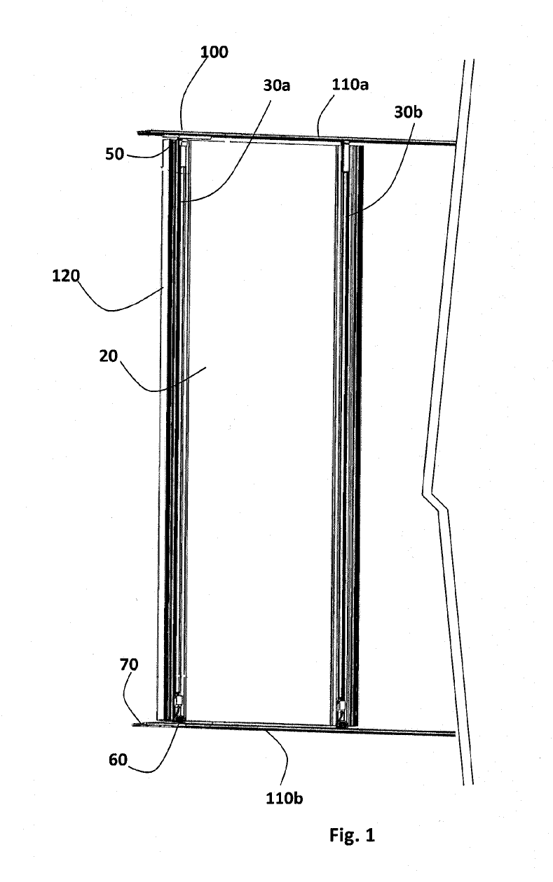

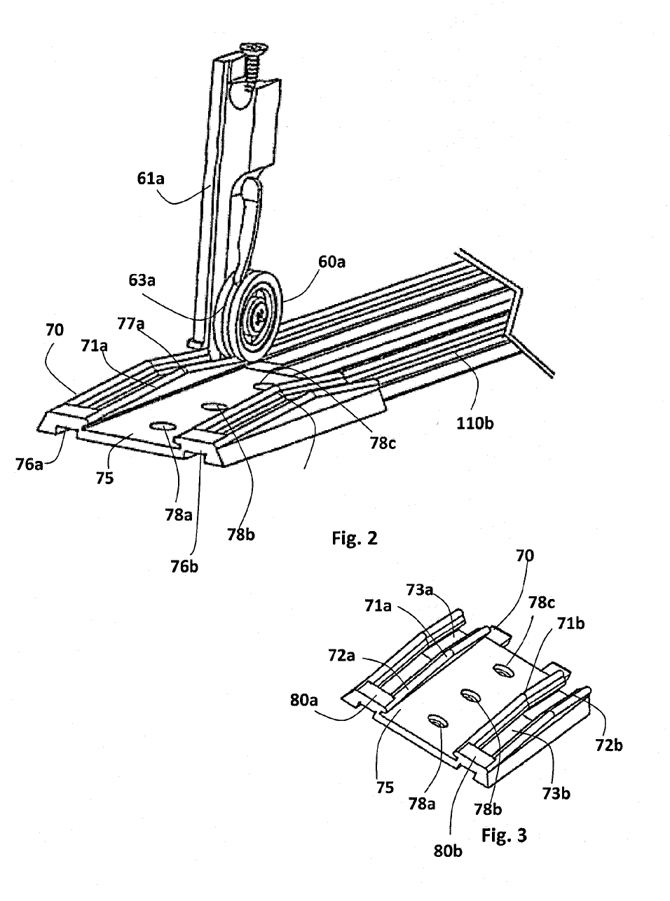

Reference is now made to FIG. 1, schematically illustrating a closet 100 having a system for preventing slamming of a sliding door 20 against a frame wall 120 of the closet 100 including a soft closing device 70 having multiple guiding members 80a and 80b having triangularly shaped elevated protruding sections 71a and 71b configured to guide slidable or rollable members such as wheels connected to the door therethrough; and a piston based buffer apparatus 50 installed at an upper part of the frame wall 120 of the closet 100, according to some embodiments of the invention. The closet 100 includes two tracks of the sliding door(s) thereof: an upper track 110a and a lower track 110b. The sliding door 20 connects to profiles 30a and 30b each attached to a different side of the door 20. The lower part of the profiles 30a and 30b connect to wheels 60a and 60b through connectors such as connector 61a shown in FIG. 2. The buffer apparatus 50 is located such that it will coordinate its buffering with the closure softening operation of the soft closing device 70. For example, the buffer apparatus 50 may be located such that the piston plunger thereof engages the frame wall 120 of the closet exactly when the door is lifted over the protruding sections 71a and 71b.

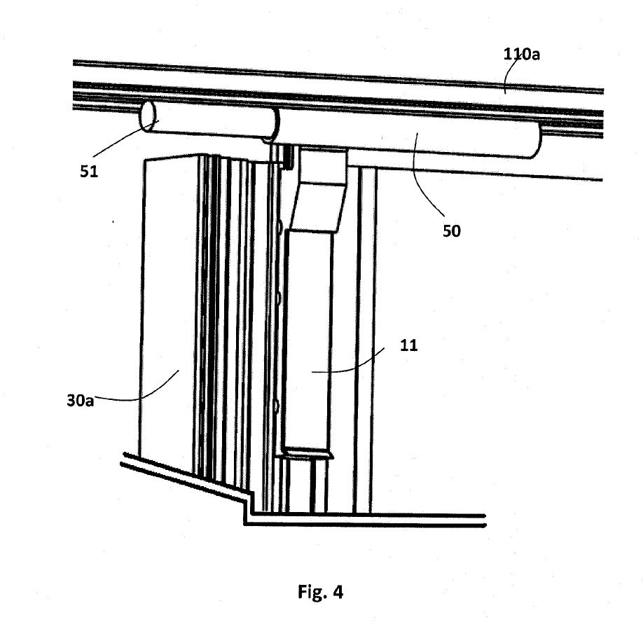

FIGS. 2 and 3 shows details of the soft closing device 70, according to some embodiments of the invention. According to these embodiments, the soft closing device 70 includes a base section 75 and multiple elevated protruding sections having slopes forming a triangular hill shape such as protruding sections 71a, 72a, 71b and 72b. Each protruding section such as 71a, 72a, 71b and 72b includes two opposite slopes creating a peak wherein each two protruding sections such as 71a and 72a or 71a and 72a form a recess 73a or 73b therebetween. This shape forces the sliding door 20 to slow down when slid upwardly in one of the slopes for preventing it from slamming and then once exceeding the peak, the weight of the sliding door 20 (due to the gravitational force) allows the sliding door 20 to reach the profile it should interface for being closed.

In this case, the soft closing device 70 is positioned at the edge of the lower track 110b of the closet 100 to allow the sliding element 60a to be directed to slide over one of the inner protruding sections 71a for preventing slamming of the door against the frame wall 120 side. The elevated hill-like shape of the protruding section 71a forces the sliding element 60a (and the side of the sliding door 20 it connects to) to slide up a first slope of the protruding section 71a until reaching its peak 77a and then (passing the peak 77a) sliding down the other slope of the protruding section 71a until reaching the end of the lane of the track 110a. The rising upwardly of the sliding element 60a slows down the entire sliding door 20 sliding movement causing it to decelerate, thereby preventing forceful slamming thereof against the frame wall 120 of the closet 100.

According to some embodiments, as shown in FIG. 2, in the area under the protruding sections 71a-72b the base section 75 has grooves 76a and 76b configured for interlocking or meshing with the lower track 110b at any location thereover either at an edge thereof proximal to the frame wall of the closet or anywhere else.

According to some embodiments of the invention, as illustrated in FIG. 2, the wheel sliding element 60a has a groove 63a. In this case the soft closing device 70 will be position to allow the groove 63a of the wheel sliding element 60a to slide over the protruding section 71a such that the protrusion width and location fits into the groove 63a. In other cases, in which a non-grooved wheel sliding element is used, the wheel can pass within a recess 72a or 72b between two adjacent protruding sections such as between protruding sections 71a and 73a or 71b and 73b or in other soft closing device 70 configuration inside and along a groove of a single protruding section.

It is also illustrated in FIG. 2 that the bottom side of the soft closing device 70 is configured to suit the edge of the lower track 110a simply allowing placing the soft closing device 70 over the track edge. The soft closing device 70 may also include openings such as openings 78a, 78b and 78c to allow securing the device 70 to the track 110a by using one or more fasteners such as by using screws.

FIG. 4 shows a zoom-in view of the buffer apparatus 50, according to some embodiments of the invention. The buffer apparatus 50 can be installed at the edge of the upper track 110a or (as illustrated in FIG. 4) installed at the upper side of the profile 30a that faces the frame wall 120. Alternatively, in cases in which the door 20 does not connect to profiles, the buffer apparatus 50 can be installed at an edge of the sliding door 20. In this case, illustrated in FIG. 4, the buffer apparatus 50 connects to the profile 30a via a connecting member 11.

According to some embodiments illustrated in FIG. 4, the buffer apparatus 50 includes a piston 51 such as a pneumatic or hydraulic piston or a gas spring, where the plunger of the piston protrudes from the door 20 in the direction facing the frame wall 120, configured for having a plunger of the piston 51 being inserted into a cylinder thereof when the plunger hits the frame wall 120. This mechanism serves as an auxiliary safety mechanism for preventing the door 20 from slamming at it upper side. Optionally, the buffer apparatus connects to the sliding element that is configured to slide along the upper track 110a (not shown). In other embodiments, the buffer apparatus is installed at an upper side of the door so as to avoid disturbing the sliding of the upper sliding element(s).

The height of the protruding section(s) should not exceed a predefined height so as to avoid over-lifting the sliding door. This threshold is calculated according to the height of the opening into which the door should fit (e.g. the height of closet frame).

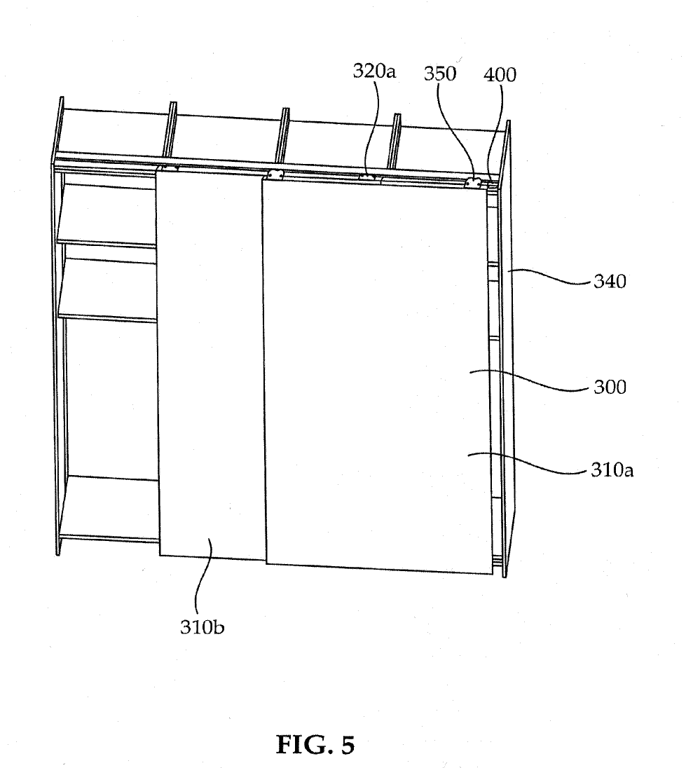

Reference is now made to FIGS. 5, 6 and 7A-7B, schematically illustrating a soft closing device 400 for preventing slamming of at least one sliding door 310a or 310b of a closet 300 installed at an upper track 320a of the closet 300, according to other embodiments of the invention. Each sliding door 310a/310bb connects to one or more slidable assembly 350 each having one or more slidable elements such as wheels 351a and 351b configured for sliding (rolling) through the upper track 310a and some for sliding over the lower track 310b of the closet 300 for opening and closing of the closet doors 310a and 310b.

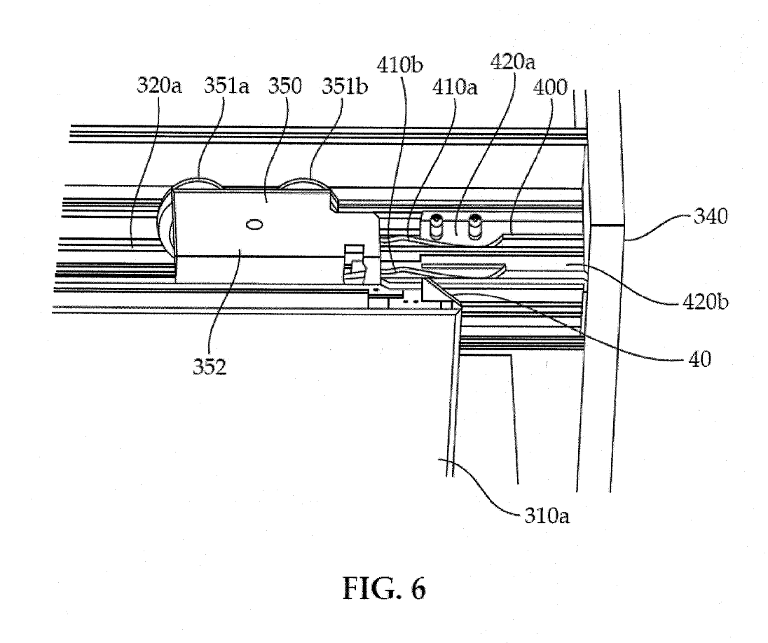

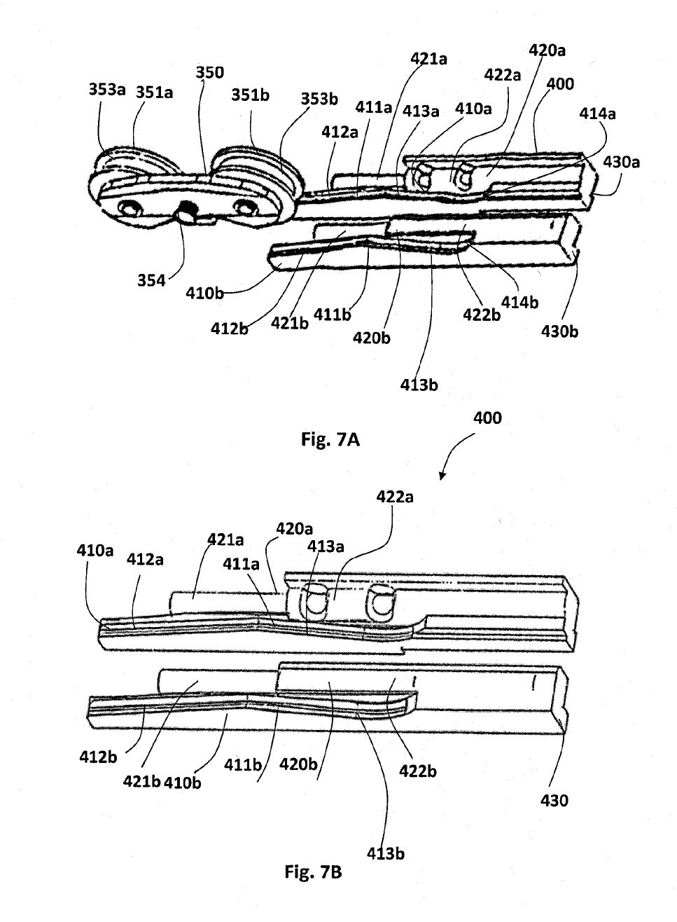

According to some embodiments, as illustrated in FIGS. 6 and 7A-7B, the soft closing device 400 includes two guiding members 410a and 410b and two piston based buffer members 420a and 420b. Each buffer member 420a/420b includes a piston tube 422a/422b and a plunger 421a/421b positioned therein and may be a spring based piston (such as a gas spring), a pneumatic or hydraulic piston and the like. The soft closing device 400 is located at an edge of the upper track adjacent to the frame wall of the closet 340 (see FIG. 6), between the frame wall 340 and the slidable assembly 350 to force one or more of the sliding elements 351a and 351b to pass through the guiding member 410a of the soft closing device 400. In this configuration, another part of the slidable assembly 350 such as a connector 352 thereof, configured for connecting the assembly 350 to the sliding door 310a or to a profile 40 connected thereto, is located in a manner that forces it to hit the plunger 421a/421b of the buffer member 420a for buffering it when the door 310a is forcefully slammed. In this way, there is a combined slamming prevention and buffering caused by the two combined members 410a and 420a of the soft closing device 400.

As shown in FIG. 6B, the connector 352 of the slidable assembly 350 connects to a profile 40 that connects to the sliding door 310a side. The profile 40 may be removable and used for enforcement of the door 310a. In other embodiments, the connector 352 connects directly to the sliding door 310a.

As shown in details in FIGS. 7A and 7B, each guiding member 410 includes a protruding section 411a and 411b each having two opposite slopes 412a and 412b and 413a and 413b, creating a peak and another recess 414a and 414b closer to the frame wall of the closet 340. Each wheel 351a/351b includes a groove 353a/353b for fitting over the track 320a as well as over the protruding section 411a or 411b of the guiding member 410a or 410b. Each wheel 351a or 351b is located such that it will slide from above the track 320a and above the guiding member 410a or 410b such that the weight of the sliding door 310a is carried by the upper slidable assembly 350, in these embodiments in which the soft closing device 400 is located over the upper track 320a in a hovering sliding doors configuration.

Once the door 310a is closed (whether forcefully or not) the wheel 351a will first ascend over the first slope 412a, which will slow the wheels 351a and 351b as well as the sliding door 310a down and then pass the peak and will descend over the second opposite slope 412b, buffered by the piston 421a and blocked by the wall of the recess 414. This movement orbit forced by the design of the soft closing device 400 allows preventing the door 310a from forcefully slamming against the frame 340.

It is clear that there may be more than one soft closing device 400 installed at the upper track 320a edges for preventing slamming and allow soft closing of all sliding doors of the closet.

According to some embodiments, as shown in FIG. 7A, the soft closing device 400 has grooves 430a and 430b configured for interlocking or meshing with the upper track 320a.

According to some embodiments, the soft closing device according further comprises one or more fixating mechanisms such as screw threads or nails holes for fixating the soft closing device to the track of the storage unit. In other embodiments, the device can be attached to the track by using adhesive means or by welding it to the track, depending on the track material and design. The soft closing device, as mentioned above, will be fixated to the track at a proximal edge of the track in respect to the frame wall of the storage unit i.e. at the edge of the track that engages and is adjacent to the frame wall.

In other embodiments the same mechanism of the soft closing device 400 described above may be used for soft closing of other closable components that can be closed and open by sliding over tracks of any type of storage unit such as drawers, slidable shelves and the like.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1-10. (canceled)

11. A system for soft closing for preventing a closable component from forcefully slamming against a frame wall of a storage unit, said system comprising:
a) a guiding member comprising:
a base section; and
at least one protruding section connected to said base section, said protruding section comprises at least one slopes creating a peak for forcing the closable component to descend once reaching the guiding member, wherein said guiding member is installed at the edge of the track in proximity to the frame wall of the storage unit;
and
b) a buffer member installed at an edge of said closable component or at an edge of said wall frame for buffering the movement of the closable component when descending.

12. The system according to claim 11, wherein said buffer member is installed at an edge of an upper track of the storage unit that is adjacent to the frame wall and said guiding member is installed at an edge of a lower track of the storage unit at an edge that is adjacent to the frame wall.

13. The system according to claim 11, wherein each said guiding member comprises two protruding sections forming a recess there between.

14. The system according to claim 11, wherein each guiding member has grooves configured for interlocking or meshing with the track at an edge of the track that is adjacent to the frame wall of the storage unit.

15. The system according to claim 11, wherein said buffer member comprises at least one piston movable in a designated piston tube.

16. The system according to claim 11, wherein each of said at least one protruding section comprises two opposite slopes forming a peak for guiding the closable component there through when closing such that said closable component will first ascend and thereby slow down and then descend to reach the edge of the track.
